(19) United States
(12) Patent Application Publication
(10) Pub. No.: US 2009/0010461 A1
(43) Pub. Date: Jan. 8, 2009

(54) HEADSET ASSEMBLY FOR A PORTABLE MOBILE COMMUNICATIONS DEVICE

(76) Inventors: Gunnar Klinghult, Lund (SE); Kent Palsson, Helsingborg (SE); Colin Eckhart, Raleigh, NC (US)

Correspondence Address: WILLIAMS MULLEN, P.O. Box 12109, Research Triangle Park, NC, 27709-2109, US

(21) Appl. No.: 11/772,374

(22) Filed: Jul. 2, 2007

(51) Int. Cl. H04R 5/04; H04R 5/02

(52) U.S. Cl. 381/309; 381/311

(57) ABSTRACT

Disclosed is a headset assembly communicable with a portable device capable of receiving and processing biological sensor data. The headset assembly includes a body portion, an earbud coupled with the body portion, a speaker component coupled with the earbud, one or more bio sensors displaced about the outer surface of the earbud that can monitor and pick-up biological characteristics of the user when in contact with the user's skin, and means for coupling the headset assembly with the portable device.

### BRIEF DESCRIPTION OF THE DRAWINGS

FIG. 1 is a side perspective view of a wired earbud headset for communicating signals with a portable mobile communications device.

FIG. 2 is a front perspective view of a wired earbud headset for communicating signals with a portable mobile communications device.

FIG. 3 is a side perspective view of a wireless earbud headset for communicating signals with a portable mobile communications device.

FIG. 4 is a block diagram illustrating the communications environment of a wired earbud headset or a wireless earbud headset with a portable mobile communications device.

FIG. 5 is a block diagram side view illustration of one embodiment of a wired earbud headset and some of the components included therein.

FIG. 6 is a block diagram front view illustration of one embodiment of a wired earbud headset and some of the components included therein.

FIG. 7 is a block diagram side view illustration of one embodiment of a wireless earbud headset and some of the components included therein.

FIG. 8 is a block diagram side view illustration of another embodiment of a wired earbud headset including a pivotal boom arm and sensor component.

FIG. 9 is a block diagram side view illustration of another embodiment of a wireless earbud headset including a pivotal boom arm and sensor component.

FIG. 10 is a block diagram illustrating components for processing sensor signal data within a portable mobile communications device communicated from a sensor equipped earbud headset.

### DETAILED DESCRIPTION OF EMBODIMENTS OF THE INVENTION

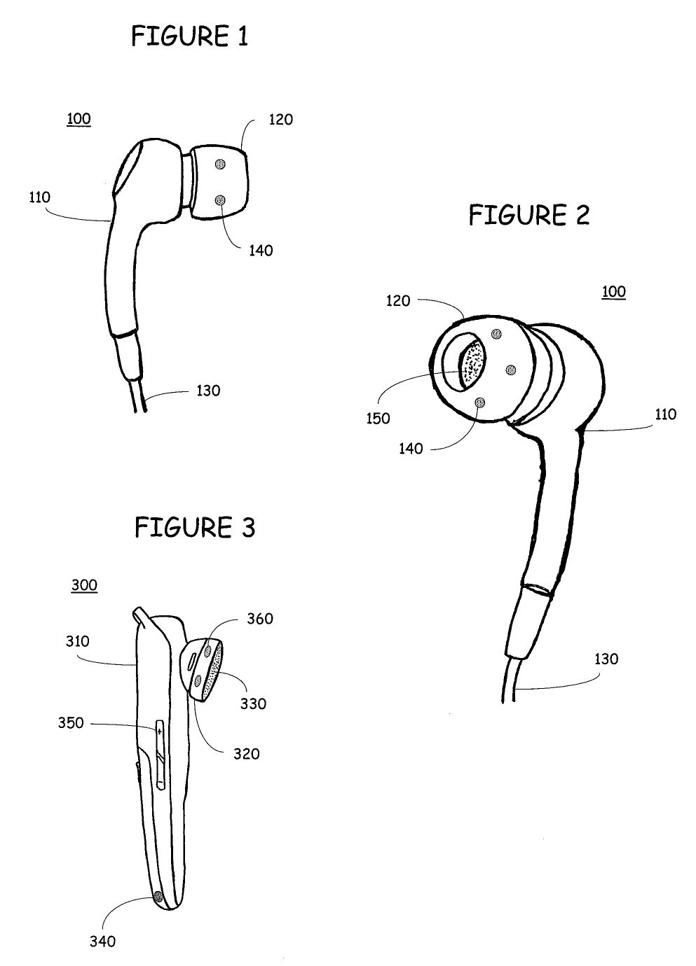

FIGS. 1 and 2 are a side and front perspective view respectively of a wired earbud headset 100 for communicating signals with a portable mobile communications device. The earbud headset 100 shown is adapted to fit in the ear canal of a user such that audio signals originating in a portable mobile communications device (to which it is attached) can be reproduced directly into the user's ear. Some wired headset assemblies can include a single earbud tethered to the portable mobile communications device or may include a pair of earbuds, one for each of the user's ears. A two earbud headset assembly is common especially for portable mobile communications device's that also function as media devices such as, for instance, an MP3 music player. It is immaterial whether two earbuds or only one earbud are utilized as each earbud may contain the specific components to be described herein.

The wired earbud headset 100 includes a body component 110 that receives a wire 130 on one end that is connected (or connectable) to a portable wireless communication device and rounded bulbous portion on the other end that is adapted to fit snugly and comfortably within the user's ear. The rounded bulbous portion includes the earbud itself 120 that is wrapped around a small speaker component 150 (shown in FIG. 2). The earbud 120 is typically (but not necessarily) comprised of a soft semi-deformable material that substantially fills the user's ear canal when inserted therein for use. While in use, the earbud 120 will be and remain in contact with some portion of the user's ear in order to remain in place. One or more sensors 140 can be dispersed about the outside surface of earbud 120 such that the sensors will be pressed against a portion of the user's ear when the earbud is inserted and operating in the user's ear.

The sensors 140 can vary in type but are designed to sense one or more biological characteristics of the user including, but not limited to, body temperature, heart rate, perspiration/dehydration characteristics, and blood chemistry analysis.

With respect to body temperature, a thermal sensor designed and adapted to sense the body temperature of the user when the thermal sensor is in contact with the user's ear can be implemented. Accurate body temperature readings that are sent to and processed by a portable mobile communications device (or other similar device) and displayed to the user can provide for detection and advanced warning of serious medical conditions such as heatstroke. The user can immediately take corrective/preventive action to reduce his/her core body temperature.

With respect to heart rate, the sensors could comprise a pair of electrodes in contact with the user's skin within the ear. A differential amplifier could measure the voltage signal between each electrode to obtain a heart rate value. The electrodes (sensors) can be made of conducting rubber or plastic that can be a part of the acoustical seal towards the ear.

With respect to perspiration/dehydration, the resistivity between the electrodes described above can be measured. The resistivity is an indication of transpiration that can be used in a calculation to determine a level of dehydration of the user. The information can be presented to the user via a display on the portable mobile communications device (or other similar device) prompting the user to start drinking liquids to re-hydrate.

With respect to blood chemistry analysis, the sensors could be a collection of microneedles that pierce the skin of the user when the headset assembly is operatively inserted into the user's ear. The microneedles can be inserted into the bloodstream of the user allowing for blood chemistry readings that can be passed to a portable mobile communications device (or other similar device) and presented to the user.

One such blood chemistry reading can be a measure of lactic acid in the bloodstream as well as a measure of blood glucose levels. Also, blood oxygen levels can be determined. Such readings can provide insight when performing physical training.

FIG. 3 is a side perspective view of a wireless earbud headset 300 for communicating signals with a portable mobile communications device. Wireless earbud headsets are quite popular with user's because of the freedom of motion they afford. Typically, a wireless earbud headset utilizes the Bluetooth™ short range RF protocol to exchange signals with a portable mobile communications device. Bluetooth™ is a low power short range RF transceiver system that is ideal for a headset application because the earbud headset and the portable mobile communications device are usually not more than the 20-30 foot effective range of Bluetooth™.

The exterior of the wireless earbud headset 300 includes a body portion 310 that houses the internal communications components (e.g., RF transceiver, antenna, etc.) and an earbud portion 320 that includes a speaker component 330. Near the bottom of the body portion 310 is a microphone 340. Also shown are control buttons 350 for assisting in the operation of the wireless earbud headset 300. Not shown is an over-the-ear piece that is sometimes included with certain designs that helps hold the entire assembly in place when the earbud is inserted into the user's ear canal. Also shown displaced about the outside of earbud 320 are one or more sensors of the type previously described above.

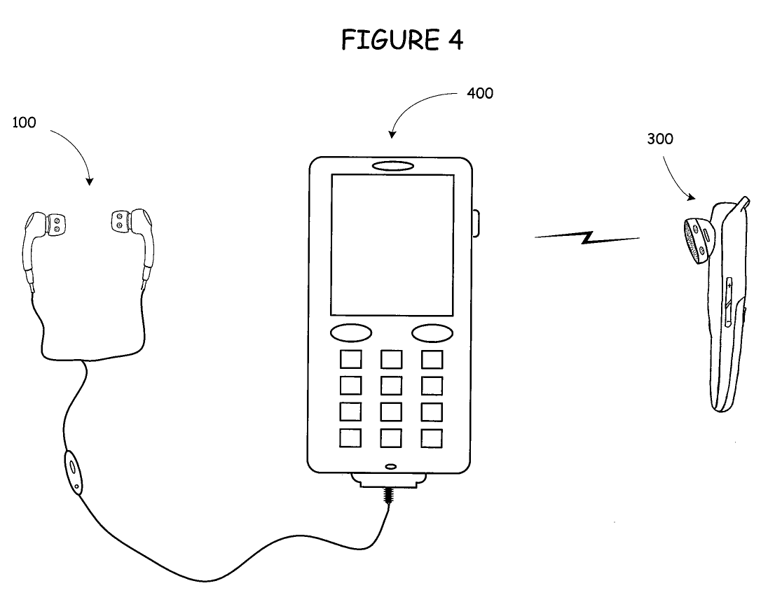

FIG. 4 is a block diagram illustrating the communications environment of a wired earbud headset or a wireless earbud headset with a portable mobile communications device. Portable mobile communications device usage has become ubiquitous among the population of the United States and globally. These devices are becoming increasingly robust as additional features and applications are included making these devices far more than simply a mobile phone. Wired and/or wireless headsets or headset assemblies are one of if not the most common accessory used in conjunction with portable mobile communications devices. Headset use frees the user's hands for other activities and, more importantly, provides a safer alternative when performing acts such as driving a motor vehicle.

A wired headset 100 or a wireless headset 300 as shown in FIG. 4 can communicate directly with a portable mobile communications device 400. The typical form of communication involves exchanging audio signals between the devices for purposes of carrying out a conversation. In addition to the audio signals, there are control signals that facilitate setting up and conducting telephone calls.

The embodiments described herein also contemplate additional data exchanges relating to user biometric conditions as determined by sensors displaced about the headset assembly. The sensors gather various biological data from the user as a result of being in contact with the user's skin. This biological data is then forwarded to the portable mobile communications device via the headset assembly to a be input to a specific application that processes the biological data and presents it to the user via one or more of the output options available to the portable mobile communications device.

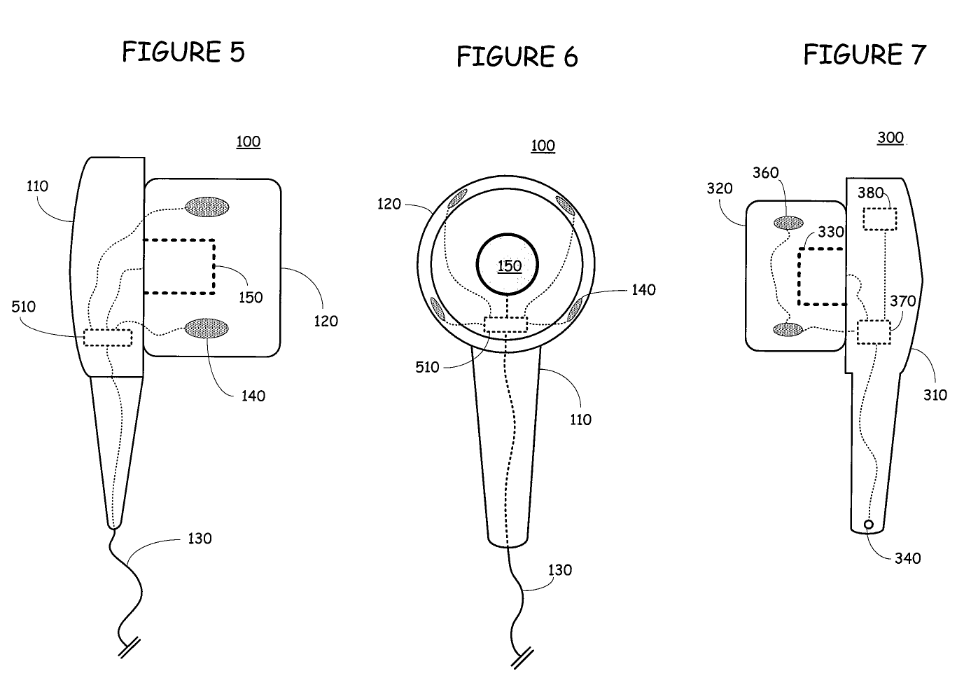

FIGS. 5 and 6 are a block diagram side view and front view illustration respectively of one embodiment of a wired earbud headset and some of the components included therein. The wired earbud headset 100 includes a body portion 110 that houses a speaker portion 150. The speaker portion 150 is surrounded by an earbud 120. Earbud 120 has one or more bio-sensors 140 displaced about its outside surface. A wire 130 is coupled to the body portion 110 and serves to convey electrical signals between the wired earbud headset 100 and another device such as a portable mobile communications device (not shown). Also included within the body portion 110 is a signal multiplexer 510 that serves to combine sensor signals and audio signals together. Alternatively, the sensor signals and the audio signals can remain independent and be separately conveyed between the wired earbud headset 100 and the other device. FIG. 6 is a block diagram front view illustration showing one possible orientation of the bio-sensors 140 displaced about the outside surface of earbud 120. Not shown in FIG. 5 or 6 is the microphone component of the wired earbud headset assembly 100. The microphone component typically is connected in-line to wire 130 and dangles below the body portion 110 such that it can pick up spoken utterances more easily.

FIG. 7 is a block diagram side view illustration of one embodiment of a wireless earbud headset 300 and some of the components included therein. The components shown herein are very similar to those described in FIGS. 5 and 6 for the wired earbud headset assembly 100. There is a body portion 310 that houses a speaker portion 330. The speaker portion 330 is surrounded by or comprises an earbud 320. Earbud 320 has one or more bio-sensors 360 displaced about its outside surface. A Bluetooth™ transceiver 380 is included within the body portion 310 and serves to convey electrical signals between the wireless earbud headset 300 and another device such as a portable mobile communications device (not shown). A microphone 340 is displaced around the bottom of the body portion 310 to pick-up audio signals from the user. Also included within the body portion 110 is a signal multiplexer 370 that serves to combine sensor signals and audio signals together. Alternatively, the sensor signals and the audio signals can remain independent and be separately conveyed between the wireless earbud headset 300 and the other device.

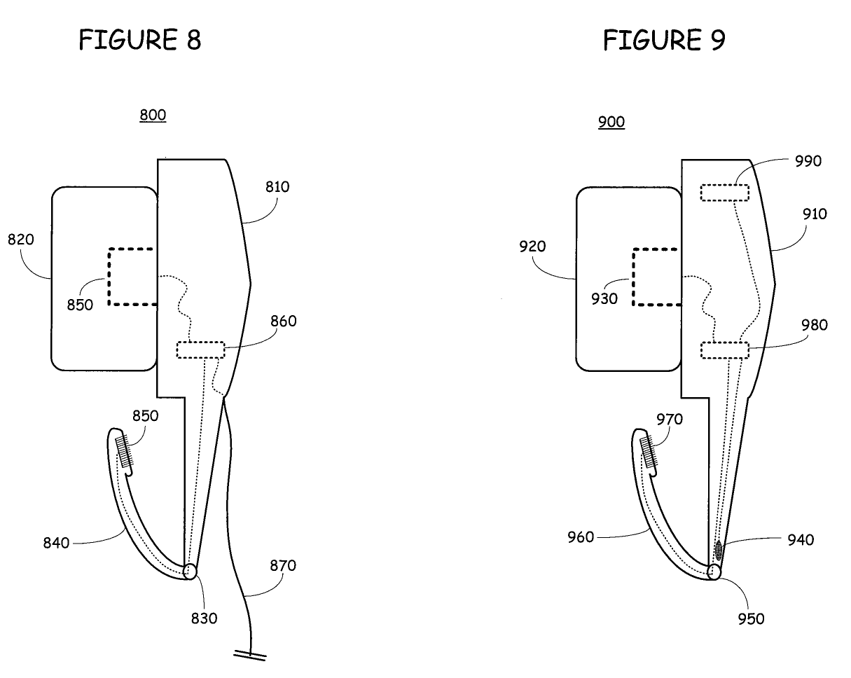

FIG. 8 is a block diagram side view illustration of another embodiment of a wired earbud headset 800 including a pivotal boom arm 840 and sensor component 850. In this embodiment, the sensor component 850 mechanism is implemented as a series of micro-needles that penetrate the surface of the user's skin when the entire headset assembly 800 is operatively placed in the user's ear and clipped into place.

The lower part of body portion 810 includes a boom pivot 830 that couples the boom arm 840 and the body portion 810 so that the boom arm 840 can be pivotally moved to and held in contact with the user's ear lobe such that the microneedles penetrate the earlobe when the entire headset assembly 800 is operatively inserted into the user's ear. The body portion 810 is also coupled to an earbud 820 that surrounds or is comprised of a speaker component 850. Also within the body portion 810 is a signal multiplexer 860 that serves to combine sensor 850 signals and audio signals together. Alternatively, the sensor signals and the audio signals can remain independent and be separately conveyed between the wired earbud headset 100 and the other device.

FIG. 9 is a block diagram side view illustration of another embodiment of a wireless earbud headset including a pivotal boom arm 960 and sensor component 970. The components of FIG. 9 are similar to those of FIG. 8. FIG. 9 replaces the tethering wire 870 shown in FIG. 8 with a Bluetooth™ transceiver 990 to handle the data/signal exchanges between the headset assembly 900 and a portable mobile communications device, for instance. The remaining components: body portion 910, earbud 920, speaker component 930, microphone 940, boom pivot 950, boom arm 960, sensor component 970 mechanism, and signal multiplexer 980 serve the same functions as described in FIG. 8.

FIGS. 8 and 9 illustrate micro-needles attached to a boom arm as a means for providing biological sensors. Alternatively, the microneedles could be displaced about the earbud shown in FIGS. 5-7. This alternative location would remove the need for a separate boom arm to house the set of microneedle sensors.

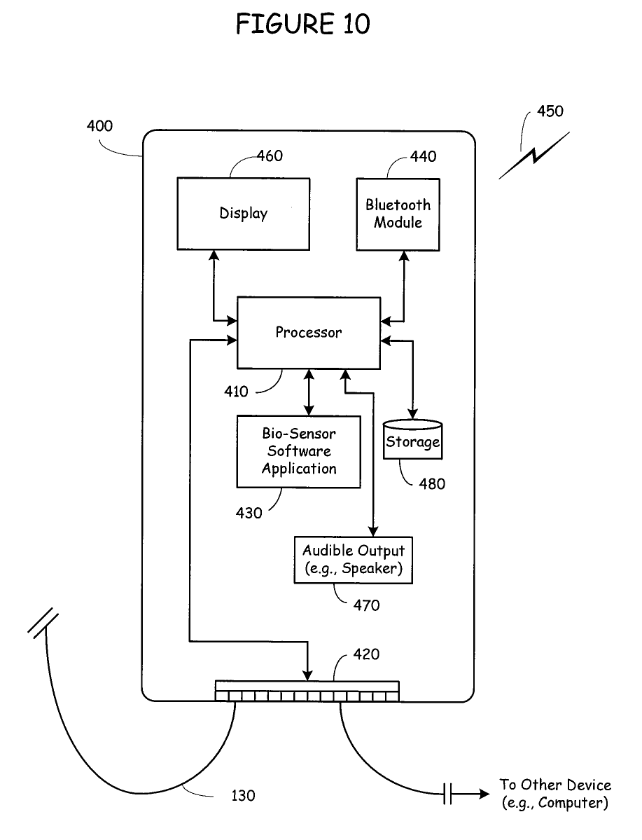

FIG. 10 is a block diagram illustrating components for processing sensor signal data within a portable mobile communications device 400 communicated from a sensor equipped earbud headset (wired or wireless). A processor 410 within the portable mobile communications device 400 serves to receive and process sensor signals according to a bio-sensor software application 430 that resides within and is executable by the portable mobile communications device 400. A device interface 420 provides a coupling point where a wired headset assembly can introduce its signals to the portable mobile communications device 400. A Bluetooth™ transceiver module 440 performs this function for a wireless headset assembly. The bio signals/data are then operated on the processor 410/bio-sensor application 430 combination to produce a result that can be formatted and output to the user via one or more of the portable mobile communications device's 400 user output options including, but not limited to, a display 460 or a speaker 470. The manipulated data may also be stored within a storage device 480 for later retrieval or analysis. The portable mobile communications device 400 can also export the bio-data via interface 420 or Bluetooth™ transceiver module 440 to another device such as a computer for further analysis or processing.

In a typical application, a user may wish to monitor the progress of a workout using the system described herein. For example, the user is about to embark on a 5 mile run and wishes to track his/her vital statistics during the exercise period. The user inserts a bio-sensor equipped earbud headset assembly (either wired or wireless) into his/her ear and ensures that it is operatively coupled with a portable mobile communications device (or other portable device). The sensors monitor various biological characteristics such as body temperature, perspiration/dehydration, blood pressure, pulse rate, etc. This data is then periodically forwarded to the portable mobile communications device where it is processed according to a resident software application. Based on the parameters of the software application, the bio data is formatted and output to the user for analysis. For instance, the portable mobile communications device display can provide temperature, pulse, and blood pressure updates at pre-defined intervals during the exercise period. The user can inspect these readings to determine whether to increase his/her level of exertion or keep it the same. The software can be programmed to alert the user when certain threshold or benchmark levels have been met or obtained. These threshold/benchmark levels can indicate personal goal achievements or dangerous level indicators.

The workout information can be saved internally to a storage device where it can be later downloaded to another device for further analysis that can track personal progress over longer time periods.

In another application, the user can keep the headset assembly in place during normal activity to monitor certain bio-characteristics that can be processed to indicate a level of stress the user may be experiencing. If the stress level exceeds a predefined threshold, the user can be alerted and attempt to relax him/her self.

While the present disclosure has used a portable mobile communications device as an illustrative example for a device in communication with the various embodiments of earbud headsets described herein, it would be obvious to one of ordinary skill in the art to utilize another portable type device such as, but not limited to, an MP3 player (e.g., an Apple IPOD™ or the like), a personal digital assistant device (PDA), or a laptop computer or other portable/mini/micro computing device. The device in communication with the headset embodiments described herein may vary without affecting the function of the headset embodiments described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A headset assembly communicable with a portable device capable of receiving and processing biological sensor data, the headset assembly comprising:
a body portion;
an earbud speaker component coupled with the body portion;
one or more sensors that can sense biological data of the user when in contact with the user's skin; and
means for operatively coupling the headset assembly with the portable device.

2. The headset assembly of claim 1 wherein the means for coupling the headset assembly with the portable device is a wire that is capable of carrying the sensed biological data from the headset assembly to the portable device.

3. The headset assembly of claim 1 wherein the means for coupling the headset assembly with the portable device is a short range RF system that is capable of transmitting the sensed biological data from the headset assembly to the portable device.

4. The headset assembly of claim 3 wherein the short range RF system comprises a Bluetooth™ transceiver system.

5. The headset assembly of claim 3 wherein the short range RF system comprises an 802.11 transceiver system.

6. The headset assembly of claim 1 wherein the one or more sensors includes a thermal sensor for sensing body temperature.

7. The headset assembly of claim 1 wherein the one or more sensors includes a pair of electrodes for sensing heart rate levels.

8. The headset assembly of claim 1 wherein the one or more sensors includes a pair of electrodes for sensing transpiration levels.

9. The headset assembly of claim 1 wherein the one or more sensors includes a collection of microneedles for sensing blood chemistry levels.

10. A system for monitoring biological characteristics comprising:
a headset assembly comprising:
a body portion;
an earbud speaker component coupled with the body portion; and
one or more sensors that can sense biological data of the user when in contact with the user's skin;
means for operatively coupling the headset assembly with a portable mobile communications device, and
a portable mobile communications device communicable with the headset assembly, the portable mobile communications device comprising:
an interface module for receiving sensed biological data from the headset assembly;
a processor for processing the received sensed biological data according to a resident bio-sensor software application; and
a display for displaying results of the processed sensed biological data.

11. The system of claim 10 wherein the means for coupling the headset assembly with the portable mobile communications device is a wire that is capable of carrying the sensed biological data from the headset assembly to the portable mobile communications device.

12. The system of claim 10 wherein the means for coupling the headset assembly with the portable mobile communications device is a short range RF system that is capable of transmitting the sensed biological data from the headset assembly to the portable mobile communications device.

13. The system of claim 12 wherein the short range RF system comprises a Bluetooth™ transceiver module embedded in the headset assembly and the portable mobile communications device.

14. The system of claim 12 wherein the short range RF system comprises an 802.11 transceiver module embedded in the headset assembly and the portable mobile communications device.

15. The system of claim 10 wherein the one or more sensors includes a thermal sensor for sensing body temperature.

16. The system of claim 10 wherein the one or more sensors includes a pair of electrodes for sensing heart rate levels.

17. The system of claim 10 wherein the one or more sensors includes a pair of electrodes for sensing transpiration levels.

18. The system of claim 10 wherein the one or more sensors includes a collection of microneedles for sensing blood chemistry levels.

19. A portable mobile communications device communicable with a sensor equipped headset assembly, the portable mobile communications device comprising:
an interface module for receiving sensed biological data from the headset assembly;
a processor for processing the received sensed biological data according to a resident bio-sensor software application; and
a display for displaying results of the processed sensed biological data.
